(19) United States
(12) Patent Application Publication
(10) Pub. No.: US 2019/0265039 A1
(43) Pub. Date: Aug. 29, 2019

(54) POSITIONING DEVICE, VEHICLE, POSITIONING DEVICE CONTROL METHOD, AND VEHICLE CONTROL METHOD

(71) Applicant: Panasonic Intellectual Property Management Co., Ltd., Osaka (JP)

(72) Inventor: NORIYUKI TANI, Kanagawa (JP)

(21) Appl. No.: 16/407,136

(22) Filed: May 8, 2019

Related U.S. Application Data
(63) Continuation of application No. PCT/JP2017/038620, filed on Oct. 26, 2017.

(30) Foreign Application Priority Data
Nov. 30, 2016 (JP) 2016-232538

(51) Int. Cl. G01C 21/12; G01S 19/49; G01C 21/20

(52) U.S. Cl. CPC G01C 21/12; G01C 21/20; G01S 19/49

(57) ABSTRACT

A positioning device to be installed in a vehicle is provided. The positioning device includes an input circuit configured to receive an input of a vehicle travel distance from the vehicle and an input of vehicle latitude and longitude information. The positioning device can determine positions of at least second and third points by integrating the vehicle travel distance based on a position of a first point. The positioning device defines a second point based on three-dimensional point cloud data representing three-dimensional shapes of a road network and a planimetric feature. Furthermore, the positioning device corrects the position of the second point based on the latitude and longitude information input to the input circuit when the vehicle is located at the second point. Furthermore, the positioning device determines the position of the third point by integrating the vehicle travel distance based on the corrected position of the second point.

### CROSS-REFERENCE TO RELATED APPLICATIONS

This application is a continuation of the PCT International Application No. PCT/JP2017/038620 filed on Oct. 26, 2017, which claims the benefit of foreign priority of Japanese patent application No. 2016-232538 filed on Nov. 30, 2016, the contents all of which are incorporated herein by reference.

### BACKGROUND

### 1. Technical Field

The present disclosure relates to a positioning device and a method for controlling the positioning device each of which obtains a relative position of a moving body by autonomous navigation and an absolute position of the moving body by radio navigation. The present disclosure also relates to a vehicle and a method for controlling the vehicle.

### 2. Description of the Related Art

Conventionally, a positioning device of this type includes, for example, a current-position detection device for a vehicle described in Japanese Patent Unexamined Publication No. H3-100420. This current-position detection device for a vehicle corrects a relative position of the vehicle obtained by autonomous navigation after the vehicle passes through a tunnel.

### SUMMARY

The present disclosure provides a positioning device, a vehicle, a method for controlling the positioning device, and a method for controlling the vehicle capable of measuring a relative position with higher precision.

One aspect of the present disclosure is directed to a positioning device to be installed in a vehicle. The positioning device includes an input circuit configured to receive an input of a travel distance of the vehicle from the vehicle and an input of latitude and longitude information of the vehicle. The positioning device determines, based on a position of a first point, positions of at least a second point and a third point by integrating the travel distance of the vehicle. The positioning device defines the second point based on three-dimensional point cloud data representing three-dimensional shapes of a road network and a planimetric feature. Furthermore, the positioning device corrects the position of the second point based on the latitude and longitude information input to the input circuit when the vehicle is located at the second point. Furthermore, the positioning device determines the position of the third point by integrating the travel distance of the vehicle based on the corrected position of the second point.

Another aspect of the present disclosure is directed to a vehicle. The vehicle includes a body, a receiver, a sensor, and an input circuit. The receiver, the sensor, and the input circuit are mounted to the body. The receiver is configured to output latitude and longitude information. The sensor is configured to output a travel distance. The input circuit is configured to receive an input of the travel distance and an input of the latitude and longitude information. The vehicle can determine, based on a position of a first point, positions of at least a second point and a third point by integrating the travel distance of the vehicle. The vehicle defines the second point based on three-dimensional point cloud data representing three-dimensional shapes of a road network and a planimetric feature. Furthermore, the vehicle corrects the position of the second point based on the latitude and longitude information input to the input circuit when the vehicle is located at the second point. Furthermore, the vehicle determines the position of the third point by integrating the travel distance of the vehicle based on the corrected position of the second point.

Still another aspect of the present disclosure is directed to a method for controlling a positioning device. The positioning device includes an input circuit configured to receive an input of a travel distance of a vehicle and an input of latitude and longitude information of the vehicle. The positioning device determines, based on a position of a first point, positions of at least a second point and a third point by integrating the travel distance of the vehicle, and is to be installed in the vehicle. The method for controlling the positioning device includes defining the second point based on three-dimensional point cloud data representing three-dimensional shapes of a road network and a planimetric feature. Furthermore, the method includes correcting the position of the second point based on the latitude and longitude information input to the input circuit when the vehicle is located at the second point. Furthermore, the method includes determining the position of the third point by integrating the travel distance of the vehicle based on the corrected position of the second point.

Yet another aspect of the present disclosure is directed to a method for controlling a vehicle. The vehicle includes a body, a receiver, a sensor, and an input circuit. The receiver, the sensor, and the input circuit are mounted to the body. The receiver is configured to output latitude and longitude information. The sensor is configured to output a travel distance. The input circuit is configured to receive an input of the travel distance and an input of the latitude and longitude information. The vehicle determines, based on a position of a first point (or a first spot), positions of at least a second point and a third point (or second and third spots) by integrating the travel distance. The method for controlling the vehicle includes defining the second point based on three-dimensional point cloud data representing three-dimensional shapes of a road network and a planimetric feature. Furthermore, the method includes correcting the position of the second point based on the latitude and longitude information input to the input circuit when the vehicle is located at the second point. Furthermore, the method includes determining the position of the third point by integrating the travel distance of the vehicle based on the corrected position of the second point.

Note here that an aspect obtained by conversion of an aspect of the present disclosure with respect to a method, a device, a system, a recording medium (including a computer-readable non-transitory recording medium), a computer program, or the like, is also effective as an aspect of the present disclosure.

The present disclosure can provide a positioning device, a vehicle, a method for controlling the positioning device, and a method for controlling the vehicle capable of measuring a relative position with higher precision.

### BRIEF DESCRIPTION OF DRAWINGS

FIG. 1 is a block diagram showing a configuration of a vehicle having a positioning device according to an exemplary embodiment of the present disclosure.

FIG. 2 is a flowchart showing a processing procedure in the positioning device of FIG. 1.

FIG. 3 is a flowchart showing a detailed processing procedure of a processing for deciding a corrected position of FIG. 2.

FIG. 4 is a flowchart showing a processing procedure in a positioning device according to a modified example.

FIG. 5 is a flowchart showing a detailed processing procedure of a processing for deciding a corrected position of FIG. 4.

### DETAILED DESCRIPTION OF PREFERRED EMBODIMENTS

Prior to describing exemplary embodiments of the present disclosure, problems in the device of the conventional technology are described briefly. It is difficult to improve the precision of the relative position obtained by autonomous navigation only by carrying out correction only after passing through a tunnel.

Hereinafter, a positioning device according to an exemplary embodiment of the present disclosure is described in detail with reference to drawings.

### 1. Definitions

The following Table 1 shows meanings of acronyms etc. to be used in the exemplary embodiments.

TABLE 1
Meanings of acronyms etc.

| Acronyms etc. | Meaning |
|---|---|
| GPS | Global Positioning System |
| ADAS | Advanced Driver Assistance System |

### 2. Configuration of Vehicle Having Positioning Device

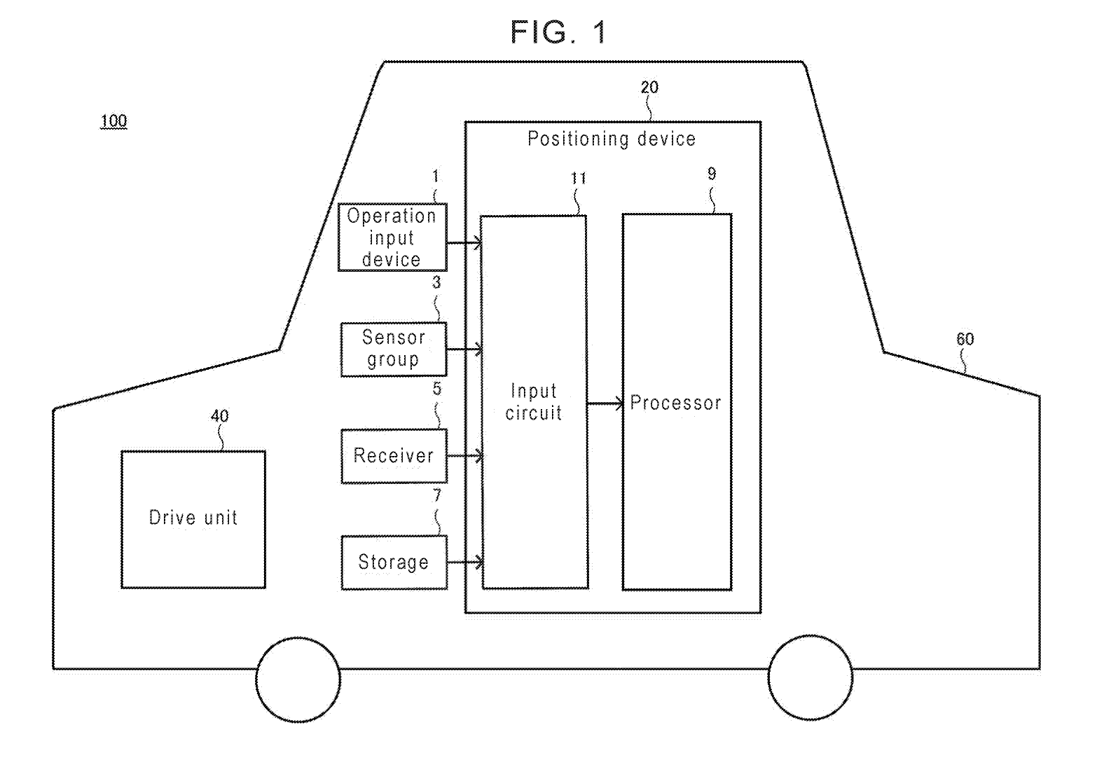

In FIG. 1, positioning device 20 is to be installed in, for example, main body 60 of a moving body such as vehicle 100. Vehicle 100 includes drive unit 40, operation input device 1, sensor group 3, receiver 5, and storage 7, in addition to positioning device 20. Positioning device 20 includes input circuit 11 and processor 9.

Operation input device 1 is, for example, a touch panel. In a case where the moving body is a vehicle, an occupant of vehicle 100 or the like operates operation input device 1 so as to set at least a destination of the moving body. Note here that the occupant or the like may operate operation input device 1 to set a starting point of the moving body.

Sensor group 3 includes, for example, an orientation sensor and a speed sensor. The orientation sensor outputs a signal indicating a travel direction of vehicle 100 (moving body). The speed sensor outputs a signal indicating a movement speed of vehicle 100 (moving body). Note here that sensor group 3 may include an acceleration sensor or an external sensor (typically, a stereo camera) instead of the speed sensor, and may include an angular acceleration sensor instead of the orientation sensor. In this way, sensor group 3 outputs information on a travel distance of vehicle 100.

Receiver 5 is typically a GPS receiver, and outputs information indicating a current absolute position of vehicle 100 (moving body) based on signals received from a plurality of artificial satellites as an example of a plurality of radio stations provided in a positioning system (GPS in the case of the present disclosure). The information indicating the current absolute position is, for example, information on latitude and longitude. The information of the absolute position (the information on latitude and longitude) is shown by a predetermined geodetic value.

Storage 7 stores so-called ADAS map data. The ADAS map data are formed based on at least three-dimensional point cloud data representing extension, shape, and the like, of each road which constructs the road network. The “extension” is, for example, the length of a road defined under the road act. The ADAS map data further include three-dimensional point cloud data showing shapes of all the objects on the ground. The above-mentioned three-dimensional point cloud data are made using an external sensor (for example, an infrared laser scanner) or a locator (for example, GPS) installed in a dedicated surveying car.

In the ADAS map data, each road is represented by a link and nodes. Each node is typically provided on a feature on a road, and includes information indicating the absolute position of a target feature. Note here that in the present disclosure, for convenience of description, this absolute position is also shown by the geodetic value. Furthermore, the feature is a folding point or an intersection on a road. The link is assigned to a road or a traffic lane linking adjacent two nodes, and includes information indicating the distance between two target nodes and/or travel time.

Note here that in general, in the ADAS map data, links and nodes are provided to not only each road but also each traffic lane constructing a road. However, the present disclosure is not interested in this respect, the detail description thereof is omitted.

Processor 9 include, for example, a microprocessor such as CPU (Central Processing Unit), main memory, and program memory mounted on a substrate (circuit board). The microprocessor loads a program stored in the program memory into the main memory and executes the program. Thereby, the microprocessor processes input information and input signals from various connectors or the like to derive the current position of vehicle 100 (moving body) in the road network represented by the ADAS map data. Note here that processor 9 can be implemented as a dedicated hardware circuit instead of a configuration using a general-purpose circuit such as CPU.

Input circuit 11 includes, for example, various connectors and a communication interface mounted on the substrate. To various connectors or the communication interface, operation input device 1, sensors forming sensor group 3, receiver 5, storage 7, and the like, are connected. Input circuit 11 receives an input of information on the travel distance of vehicle 100 from sensor group 3 of vehicle 100. Furthermore, input circuit 11 receives an input of information indicating a current absolute position of vehicle 100 from receiver 5 of vehicle 100. The information indicating a current absolute position is, for example, information on latitude and longitude.

Drive unit 40 includes engine or motor for moving main body 60 of vehicle 100.

### 3. Processing Procedure of Positioning Device

Hereinafter, a processing procedure of processor 9 is described with reference to FIGS. 1 to 3.

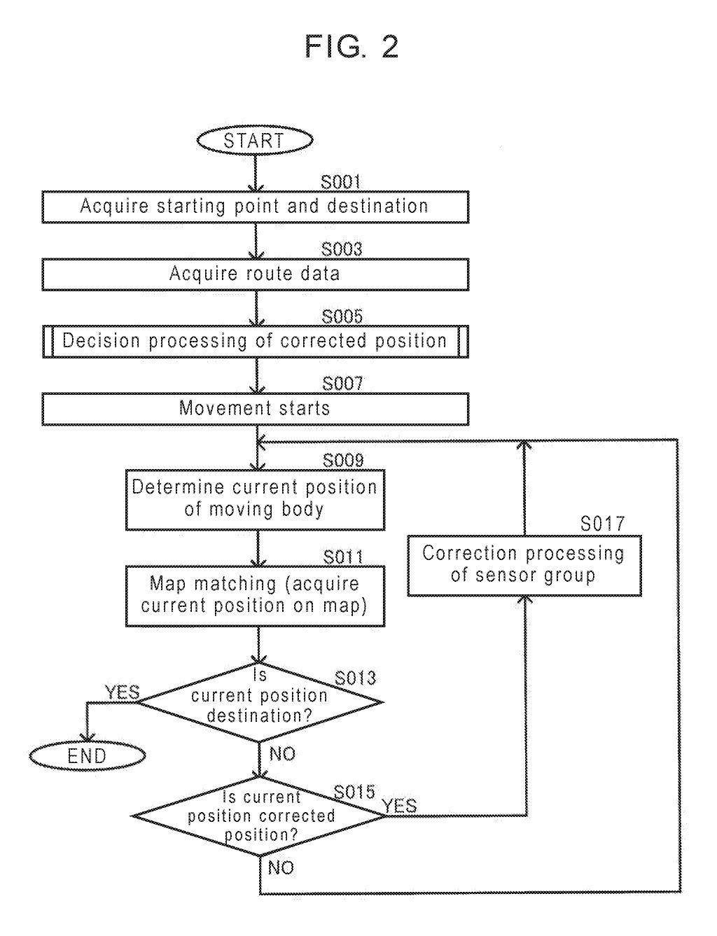

In processor 9, when a microprocessor starts execution of a program, the microprocessor acquires a starting point and a destination of a moving body (step S001 in FIG. 2).

The destination is input by the occupant or the like operating operation input device 1. Furthermore, the starting point may also be input by the occupant or the like operating operation input device 1. In this case, the microprocessor acquires both the starting point and the destination from operation input device 1 via various connectors and the like of input circuit 11.

Besides, the starting point may be a current position of a moving body. In this case, processor 9 acquires the current position as the starting point from receiver 5 via various connectors or the like of input circuit 11. Processor 9 acquires the destination from operation input device 1, and acquires the starting point from receiver 5.

Following step S001, in processor 9, the microprocessor derives a route from the acquired starting point to the acquired destination using ADAS map data stored in storage 7. More specifically, the microprocessor acquires route data representing the route from the starting point to the destination by nodes and links (step S003).

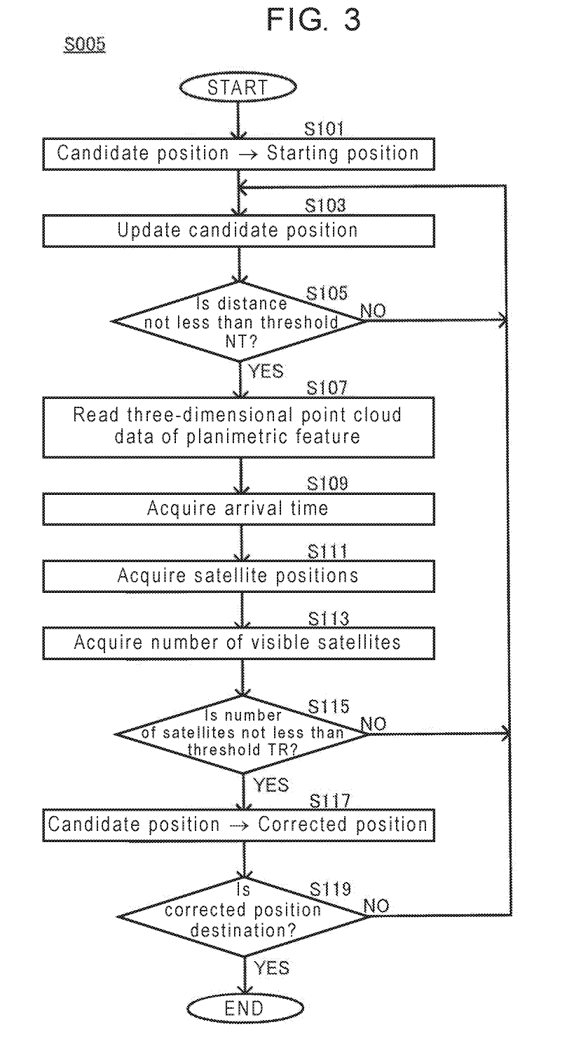

Next, in processor 9, the microprocessor performs a processing for deciding a corrected position (step S005). Hereinafter, processing in step S005 is described in detail with reference to FIG. 3.

The microprocessor firstly sets a candidate of the corrected position (hereinafter, referred to as a “candidate position”) as the starting point acquired in step S001 (step S101 of FIG. 3).

Next, the microprocessor advances the candidate position by a predetermined distance N on the route data obtained in step S003 so as to update the current candidate position (step S103). Herein, the distance N is appropriately and properly determined in a design development stage of positioning device 20. Note here that the current candidate position may be advanced by a predetermined number of links or a predetermined number of nodes instead of the distance N.

Next, the microprocessor judges whether or not a distance from a previously decided corrected position to the current candidate position is not less than a predetermined distance threshold NT (step S105). Note here that in step S105 that is the firstly executed after execution of processing of FIG. 3 is started, since the “previously decided corrected position” does not exist, the starting point may be assumed to be “the previously decided corrected position, for example.

When the judgment in step S105 is YES, the microprocessor reads the three-dimensional point cloud data of a planimetric feature existing around the current candidate position (hereinafter, referred to as “three-dimensional point cloud data of a surrounding planimetric feature) from storage 7 (step S107).

Next, the microprocessor acquires time to arrive at the current candidate position (hereinafter, referred to as “arrival time”) (step S109). This arrival time is obtained by adding travel time from the starting point to the current candidate position to the current time. This travel time is obtained by adding travel time of each link interposed between the starting point and the current candidate position in the route data.

Next, the microprocessor acquires absolute positions of the respective artificial satellites at the arrival time (hereinafter, also simply referred to as a “satellite positions”) (step S111). In GPS, for example, the orbit elements of the respective artificial satellites are included in the signals received by receiver 5 as almanac data or ephemeris data. The microprocessor acquires the satellite positions at the arrival time based on the data included in the input signal from receiver 5.

Next, the microprocessor uses the three-dimensional point cloud data of the road network and the surrounding planimetric feature and the satellite positions to predict the number of visible satellites at the current candidate position at the arrival time (step S113). A visible satellite is an artificial satellite existing within a range that can be seen from the current candidate position without being blocked by a planimetric feature in the surroundings. The processing in step S113 can be achieved using existing technology.

Next, the microprocessor judges whether or not the predicted number of visible satellites is equal to or greater than a predetermined threshold TR of the number of satellites (step S115). It is predicted that the larger the number of visible satellites is, the higher the certainty of the latitude and longitude information input to input circuit 11 is. Therefore, the threshold TR of the number of satellites is preferably selected to be 3 or more.

When the judgment in step S115 is YES, the microprocessor holds the current candidate position as the corrected position in the main memory or the like (step S117).

Next, the microprocessor judges whether or not the current candidate position arrives at the destination (step S119). When the judgment is YES, the microprocessor exits the process of FIG. 3, and performs step S007 of FIG. 2.

On the contrary, the judgment is NO in steps S105, S115, and S119, the microprocessor performs step S103 again.

In this way, in the processing in step S005, the microprocessor can define a point (or a spot), at which the certainty of the latitude and longitude information input to input circuit 11 is predicted to be greater than a predetermined value, as the corrected position, and can hold the corrected position in the main memory or the like.

Note here that in the processing in step S005, the microprocessor may define a point, at which the certainty of the latitude and longitude information input to input circuit 11 is predicted to be greater than a predetermined value, as a corrected position, using the three-dimensional point cloud data of a road network and a surrounding planimetric feature without using the satellite positions, and may hold the corrected position in the main memory or the like. For example, the microprocessor may make the certainty of the latitude and longitude information of a point having a better view higher than the certainty of the latitude and longitude information of a point having a less good view, based on the three-dimensional point cloud data.

With reference to FIG. 2 again, when the moving body starts to move toward the destination along the route (step S007), the microprocessor determines a current position of the moving body (step S009).

In step S009, the microprocessor makes an absolute position derived from the signal received from receiver 5 be a current position of the moving body to be determined in step S009. However, when the receiving situation of receiver 5 is bad, the microprocessor makes a relative position derived from a signal output from sensor group 3 be a current position of the moving body to be determined in step S009. Herein, the relative position typically shows how far and in which travel direction the moving body moves with respect to the reference position (for example, a previously determined current position). As is well known, errors tend to be superimposed in such a relative position.

Next, the microprocessor performs map matching so as to adjust the current position of the moving body acquired by the above-mentioned method to the road network represented in the ADAS map data. Thus, the microprocessor acquires the current position on the road network (Step S011).

Next, the microprocessor judges whether or not the current position of the moving body obtained in step S011 substantially matches with the destination (step S013).

When the judgment in step S013 is YES, the microprocessor ends the processing of FIG. 2. However, when the judgment is NO, the microprocessor judges whether or not the current position of the moving body obtained in step S011 substantially matches with the corrected position held in the memory (step S015).

When the judgment in step S015 is YES, the microprocessor performs correction processing of sensor group 3 (step S017). Specifically, the microprocessor derives an absolute position from the signal received from receiver 5, and makes the derived absolute position as a reference position of the relative position to be derived next.

When the judgment in step S015 is NO, or following step S017, the microprocessor performs step S009 again.

### 4. Advantageous Effect

As described above, processor 9 of positioning device 20 determines arrival time to the candidate point set on the route determined before traveling of the moving body. When the receiving situation of receiver 5 is good in the candidate point at the arrival time, the candidate point is stored as a corrected position (step S117 in FIG. 3). After the moving body starts to actually travel along the route, and when it arrives at the corrected position, processor 9 corrects the reference position of the relative position to be determined next by autonomous navigation, by, for example, substitution to highly precise absolute position obtained from an output signal of receiver 5. In this way, positioning device 20 can perform correction at the time (that is, arrival time) and at a position (that is, corrected position) appropriate for correcting the reference position. Thereby, the precision of the reference position is improved, and accordingly precision of the relative position obtained by the autonomous navigation is also improved.

### 5. Note

In the above, GPS is described as an example of the positioning system. However, the positioning system is not limited to this, and may be GLONASS (GLObal′naya NAvigatsionnaya Sputnikovaya Sistema in Russian Latin alphabet transcription (Global Navigation Satellite System in English)) or a cellular phone system.

Furthermore, the highly precise relative position determined by the autonomous navigation of the present disclosure is used to judge whether or not the moving body has arrived at the destination. However, the relative position of the present disclosure is not limited to this, and may be used to change the weighting in integrating the current positions of a plurality of moving bodies obtained from autonomous navigation, radio navigation, or the like.

Furthermore, when an absolute position by the radio navigation is much more precise than a relative position by the autonomous navigation, the relative position for the present disclosure becomes more precise, and the speed of an automatic driving vehicle may be made higher.

### 6. Modified Example

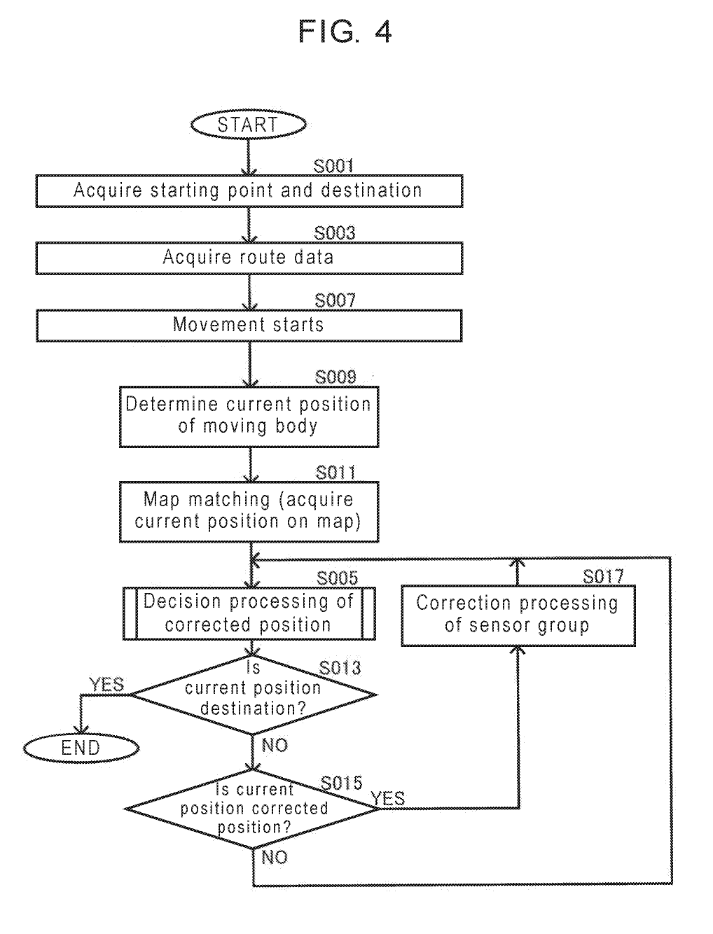

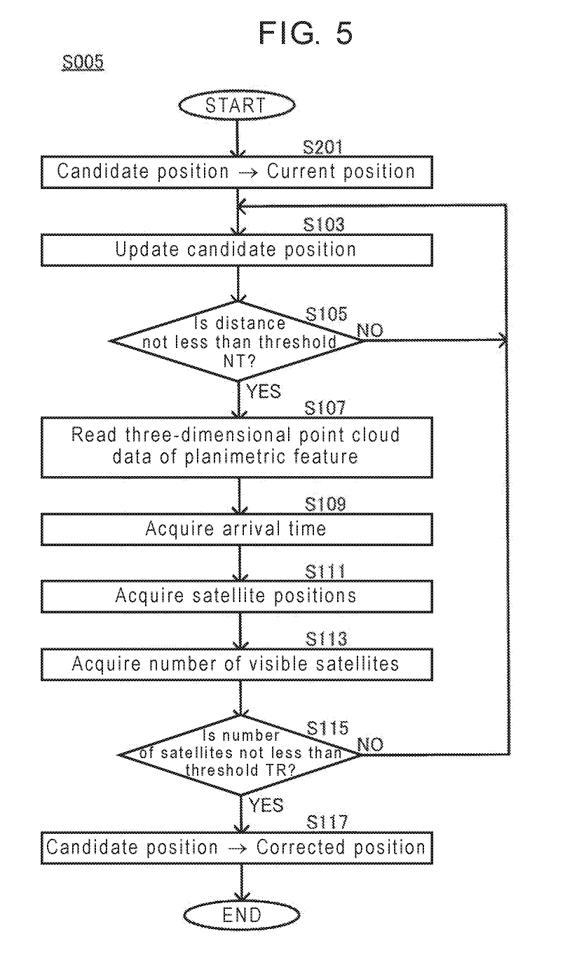

Furthermore, in the above, in a positioning device, a processing for deciding a corrected position is performed before a moving body actually travels (see step S005 of FIG. 2); however, it is not necessarily limited to this. As described with reference to FIGS. 4 and 5, in the positioning device, the processing for deciding the corrected position may be performed after a moving body actually starts to travel.

Firstly, FIG. 4 is a flowchart showing processing procedure of the positioning device according to the modified example. As comparing FIG. 4 with FIG. 2, FIG. 4 is different from FIG. 2 in that (1) step S005 is performed after step S011, and (2) after step S017 is executed and when the judgment in step S015 is NO, step S005 is performed. Since there is no other difference between both flowcharts, the same step numbers are given to the steps in FIG. 4 corresponding to those of FIG. 2, and the description therefor is omitted.

Furthermore, FIG. 5 is a flowchart showing a detailed processing procedure of step S005 in FIG. 4. As comparing FIG. 5 with FIG. 3, FIG. 5 is different from FIG. 3 in that step S101 is changed to step S201 and step S119 is not performed. Since there is no other difference between both flowcharts, the same step numbers are given to the steps in FIG. 5 corresponding to those of FIG. 3, and description therefor is omitted.

In step S201, firstly, the microprocessor sets the candidate position at the current position obtained in step S011 (step S201 of FIG. 5), and then step S103 and subsequent steps are executed.

A positioning device, a vehicle, a method for controlling the positioning device, and a method for controlling the vehicle according to the present disclosure can measure a relative position with higher precision, and are suitable for navigation devices, automatic driving vehicles, and the like.

What is claimed is:

1. A positioning device to be installed in a vehicle, the positioning device comprising:
an input circuit configured to receive an input of a travel distance of the vehicle from the vehicle and an input of latitude and longitude information of the vehicle,
the positioning device being configured to determine, based on a position of a first point, positions of at least a second point and a third point by integrating the travel distance of the vehicle,
wherein the positioning device:
defines the second point based on three-dimensional point cloud data representing three-dimensional shapes of a road network and a planimetric feature;
corrects the position of the second point based on latitude and longitude information input to the input circuit when the vehicle is located at the second point; and
determines the position of the third point by integrating the travel distance of the vehicle based on the corrected position of the second point.

2. The positioning device according to claim 1,
wherein the three-dimensional point cloud data includes data corresponding to the first point, data corresponding to the second point, and data corresponding to the third point.

3. The positioning device according to claim 1,
wherein a point at which certainty of the latitude and longitude information input to the input circuit is predicted to be greater than a predetermined value is defined as the second point, based on the three-dimensional point cloud data.

4. The positioning device according to claim 3,
wherein certainty of the latitude and longitude information at a point having a first view is made to be higher than certainty of the latitude and longitude information at a point having a second view that is less good than the first view, based on the three-dimensional point cloud data.

5. The positioning device according to claim 1, further comprising a storage configured to store the three-dimensional point cloud data.

6. The positioning device according to claim 1, further comprising a processor, which in operation:
defines the second point based on the three-dimensional point cloud data representing the three-dimensional shape of the road network and the planimetric feature;
corrects the position of the second point based on the latitude and longitude information input to the input circuit when the vehicle is located at the second point; and
determines the position of the third point by integrating the travel distance of the vehicle based on the corrected position of the second point.

7. The positioning device according to claim 1,
wherein before the vehicle starts to move from the first point, the second point is defined on a route from the first point to the third point.

8. The positioning device according to claim 1,
wherein after the vehicle starts to move from the first point, the second point is defined on a route from a position of the vehicle to the third point.

9. The positioning device according to claim 1, further comprising a receiver configured to receive a signal from a plurality of artificial satellites,
wherein the second point is defined as a position where a number of visible satellites is equal to or greater than a predetermined threshold of the plurality of artificial satellites, the number of visible satellites being predicted based on the three-dimensional point cloud data and orbit elements of the plurality of artificial satellites.

10. A vehicle comprising:
a body;
a receiver mounted to the body and configured to output latitude and longitude information;
a sensor mounted to the body and configured to output a travel distance; and
an input circuit mounted to the body and configured to receive an input of the travel distance and an input of the latitude and longitude information,
the vehicle being configured to determine, based on a position of a first point, positions of at least a second point and a third point by integrating the travel distance,
wherein the vehicle, in operation:
defines the second point based on three-dimensional point cloud data representing three-dimensional shapes of a road network and a planimetric feature;
corrects the position of the second point based on latitude and longitude information input to the input circuit when the vehicle is located at the second point; and
determines the position of the third point by integrating the travel distance of the vehicle based on the corrected position of the second point.

11. The vehicle according to claim 10,
wherein the position of the second point is corrected and an error of the sensor is corrected based on the latitude and longitude information input to the input circuit when the vehicle is located at the second point.

12. A method for controlling a positioning device, the positioning device including an input circuit configured to receive an input of a travel distance of a vehicle and an input of latitude and longitude information of the vehicle, the positioning device being configured to determine, based on a position of a first point, positions of at least a second point and a third point by integrating the travel distance of the vehicle, and the positioning device configured to be installed in the vehicle,
the method comprising:
defining the second point based on three-dimensional point cloud data representing three-dimensional shapes of a road network and a planimetric feature;
correcting the position of the second point based on latitude and longitude information input to the input circuit when the vehicle is located at the second point; and
determining the position of the third point by integrating the travel distance of the vehicle based on the corrected position of the second point.

13. The method for controlling the positioning device according to claim 12,
wherein the three-dimensional point cloud data includes data corresponding to the first point, data corresponding to the second point, and data corresponding to the third point.

14. The method for controlling the positioning device according to claim 12,
wherein a point at which certainty of the latitude and longitude information input to the input circuit is predicted to be greater than a predetermined value is defined as the second point, based on the three-dimensional point cloud data.

15. The method for controlling the positioning device according to claim 14,
wherein certainty of the latitude and longitude information at a point having a first view is made to be higher than certainty of the latitude and longitude information at a point having a second view that is less good than the first view, based on the three-dimensional point cloud data.

16. The method for controlling the positioning device according to claim 12,
wherein the positioning device further includes a storage configured to store the three-dimensional point cloud data.

17. The method for controlling the positioning device according to claim 12,
wherein before the vehicle starts to move from the first point, the second point is defined on a route from the first point to the third point.

18. The method for controlling the positioning device according to claim 12,
wherein after the vehicle starts to move from the first point, the second point is defined on a route from a position of the vehicle to the third point.

19. The method for controlling the positioning device according to claim 12,
wherein the positioning device further comprises a receiver configured to receive a signal from a plurality of artificial satellites, and
the second point is defined as a position where a number of visible satellites is equal to or greater than a predetermined threshold of the plurality of artificial satellites, the number of visible satellites being predicted based on the three-dimensional point cloud data and orbit elements of the plurality of artificial satellites.

20. A method for controlling a vehicle, the vehicle including: a body; a receiver mounted to the body and configured to output latitude and longitude information; a sensor mounted to the body and configured to output a travel distance; and an input circuit mounted to the body and configured to receive an input of the travel distance and an input of the latitude and longitude information, and the vehicle being configured to determine, based on a position of a first point, positions of at least a second point and a third point by integrating the travel distance,
the method comprising:
defining the second point based on three-dimensional point cloud data representing three-dimensional shapes of a road network and a planimetric feature;
correcting the position of the second point based on latitude and longitude information input to the input circuit when the vehicle is located at the second part; and
determining the position of the third point by integrating the travel distance of the vehicle based on the corrected position of the second point.
